(19) United States
(12) Patent Application Publication
(10) Pub. No.: US 2026/0203606 A1
(43) Pub. Date: Jul. 16, 2026

(54) METHOD AND SYSTEM FOR MULTIMODAL FUSION PREDICTION OF MARINE ENVIRONMENT BASED ON DIGITAL TWINNING

(71) Applicants: Shandong Marine Resource and Environment Research Institute, Yantai (CN); YANTAI UNIVERSITY, Yantai (CN)

(72) Inventors: Shan SUN, Yantai (CN); Xuejie SHI, Yantai (CN); Shaonan QIU, Yantai (CN); Huimin TAO, Yantai (CN); Xiaojie JIN, Yantai (CN); Zhe LIU, Yantai (CN); Bo SU, Yantai (CN); Zhilin LI, Yantai (CN); Liming WANG, Yantai (CN); Zhaowei LIU, Yantai (CN); Haonan WEN, Yantai (CN)

(73) Assignees: Shandong Marine Resource and Environment Research Institute, Yantai (CN); YANTAI UNIVERSITY, Yantai (CN)

(21) Appl. No.: 19/297,786

(22) Filed: Aug. 12, 2025

(30) Foreign Application Priority Data
Jan. 16, 2025 (CN) 2025100660654

(51) Int. Cl. G06N 5/022

(52) U.S. Cl. CPC G06N 5/022

(57) ABSTRACT

This disclosure relates to the technical field of marine environment prediction, and in particular, to a method and system for multimodal fusion prediction of a marine environment based on digital twinning. The method includes the following steps: capturing spatiotemporal correlation features of multimodal data of the marine environment based on a dynamic multimodal graph neural network; performing multi-scale feature fusion on the spatiotemporal correlation features by using a multi-scale gating unit to obtain a comprehensive feature representation; predicating the comprehensive feature representation by using a hybrid time-series prediction framework to obtain preliminary marine environment prediction data, including short-term dynamic modeling and long-term trend modeling; and performing noise fitting on the preliminary marine environment prediction data by using a generative adversarial network to generate the final marine environment prediction data.

### CROSS-REFERENCE TO RELATED APPLICATIONS

The application claims priority to Chinese patent application No. 2025100660654, filed on Jan. 16, 2025, the entire contents of which are incorporated herein by reference.

### TECHNICAL FIELD

This disclosure relates to the technical field of marine environment prediction, and in particular, to a method and system for multimodal fusion prediction of a marine environment based on digital twinning.

### BACKGROUND

With the growing demand for marine resource development and environmental protection, real-time monitoring, dynamic prediction and emergency response of a marine environment have become the focus of current research. However, traditional marine environmental monitoring methods have many shortcomings in dealing with the dynamic characteristics of the complex marine environment. First, traditional methods usually rely on a single data source, such as buoys, weather stations or satellite remote sensing. This single mode makes it difficult to fully capture multi-dimensional dynamic characteristics of the marine environment, resulting in limited monitoring scope and time continuity. Secondly, when faced with data with significant spatiotemporal variations in temperature, salinity, flow velocity, ocean waves and other factors, existing methods lack deep fusion of multimodal data during data processing and analysis, making it difficult to capture the spatiotemporal correlation between data of different modalities, resulting in insufficient accuracy in predicting change trends across time scales. Thirdly, traditional systems often rely on rule models in emergency response. These models, which are usually based on fixed empirical rules and static data, make it difficult to process complex nonlinear dynamic characteristics and cannot adapt to complex and diverse marine environments efficiently in real time, thereby seriously restricting the efficiency of monitoring and decision-making.

In recent years, a digital twinning technology, as an emerging intelligent technology, has provided new possibilities for marine environment monitoring and prediction. Through multimodal data fusion, the digital twinning technology integrates a plurality of data sources such as satellite remote sensing, buoys, and underwater sensors into a unified virtual model to reconstruct and simulate a real marine environment with high fidelity. This technology can not only sense the state of the oceans in real time, but also predict future environmental change trends, thereby effectively reducing the high cost and high risk of physical experiments. However, the current digital twinning system still has significant shortcomings in high-precision data fusion, intelligent prediction, and simulation of complex ecosystems. Especially when faced with the heterogeneity, realtime and accuracy requirements of multi-source data, existing technologies have not yet formed a unified and efficient solution. For example, in the event of processing multimodal data, the existing technologies lack an effective framework that can capture cross-modal spatiotemporal correlations of multi-source heterogeneous data. In the event of modeling the dynamic characteristics of complex ecosystems, existing prediction models are usually unable to take into account both short-term dynamic changes and long-term trend characteristics at the same time. Especially in extreme weather scenarios, the reliability and accuracy of prediction results are still low. In addition, the current digital twinning technology is still insufficient in result display and interactivity. Existing visualization methods make it difficult to intuitively present dynamic changes of complex environments, and also difficult to meet flexible analysis requirements in practical applications.

At the same time, the traditional methods make it difficult to achieve efficient integration and spatiotemporal correlation modeling while processing multi-source heterogeneous data (such as satellite remote sensing, buoy sensors and meteorological station data), due to differences in data format, resolution and time synchronization, resulting in limited monitoring accuracy and insufficient ability to capture dynamic changes. In addition, the existing methods lack the ability to jointly model short-term dynamic and long-term trends while dealing with multi-scale changes in complex marine ecosystems, especially in the prediction of extreme events (such as typhoons and tsunamis), and make it difficult to provide reliable and accurate results.

At a data fusion level, current methods mostly use simple weighted average or linear integration methods to deal with the heterogeneity and spatiotemporal dynamic characteristics of multimodal data, which cannot effectively capture a complex cross-modal and cross-spatiotemporal dependency relationship, thereby limiting the comprehensive expression of multidimensional dynamic features. At the same time, in multi-scale modeling, traditional time-series models (such as ARIMA or single deep learning models) only focus on a single time-scale feature, ignoring a coupling relationship between short-term drastic changes and long-term stable trends, resulting in low prediction accuracy. Especially in the simulation of extreme weather scenarios, the existing methods make it difficult to generate realistic abnormal data for scenario deduction. In addition, the existing systems mostly use two-dimensional static charts or simple indicator exhibition in terms of result display, and lack dynamic interactive capabilities and visual intuitiveness, making it difficult to support users' efficient analysis and understanding of complex marine environments.

### SUMMARY

This disclosure provides a method and system for multimodal fusion prediction of a marine environment based on digital twinning in view of the above-mentioned problems.

In a first aspect, this disclosure provides a method for multimodal fusion prediction of a marine environment based on digital twinning. The following technical solution is summarized as follows.

A method for multimodal fusion prediction of a marine environment based on digital twinning includes:
acquiring multimodal data of the marine environment, including satellite remote sensing, buoy sensors and weather station data;
performing data preprocessing on the acquired multimodal data;
capturing spatiotemporal correlation features of multimodal data of the marine environment based on a dynamic multimodal graph neural network;
performing multi-scale feature fusion on the spatiotemporal correlation features by using a multi-scale gating unit to obtain a comprehensive feature representation;
predicating the comprehensive feature representation by using a hybrid time-series prediction framework to obtain preliminary marine environment prediction data, including short-term dynamic modeling and long-term trend modeling; and
performing noise fitting on the preliminary marine environment prediction data by using a generative adversarial network to generate the final marine environment prediction data.

Further, the performing data preprocessing on the acquired multimodal data includes: performing data cleaning, missing value processing and normalization processing on the acquired multimodal data, wherein an averaging method is used for the missing value processing to fill a missing value, and a filling method is set to be:

$${X}_{t}^{( i )} = \{ \begin{matrix}{X}_{t}^{( i )} , {X}_{t}^{( i )} \neq NaN \\ \frac{1}{k} = {\sum }_{j = 1}^{k} {X}_{t - j}^{( i )} , {X}_{t}^{( i )} = NaN\end{matrix} \} ,$$

wherein, the missing value is a mean value of the past k moments as an estimated value of missing data at time t.

Further, the capturing spatiotemporal correlation features of multimodal data of the marine environment based on the dynamic multimodal graph neural network includes: modeling the multimodal data of the marine environment as a dynamic heterogeneous graph Gₜ=(V, Eₜ, Aₜ), wherein a node set V represents each modal data source, an edge set Eₜ represents a dynamic relationship between the data sources, and an adjacency matrix Aₜ defines an association weight between nodes. After the dynamic heterogeneous graph is constructed, the node features are propagated and updated through a graph convolution network GCN. An updating formula of each layer of graph convolution operation is:

$${H}_{t}^{( l + 1 )} = σ ( {Ã}_{t} {H}_{t}^{( l )} {W}^{( l )} + {b}^{( l )} ,$$

wherein,

$${H}_{t}^{( l )}$$

is a node feature matrix of a 1^{st} layer, W^{(l)} is a weight matrix for linear transformation, b^{(l)} is a bias vector, and σ(⋅) is a nonlinear activation function.

Further, the performing multi-scale feature fusion on the spatiotemporal correlation features by using the multi-scale gating unit includes: extracting short-term dynamic and long-term trend features from the generated features using a multi-scale gating Tanh unit, wherein local features in different time windows are captured by a convolution operation, feature selection weights are generated by a gating mechanism through a Sigmoid function, Tanh activation is used to introduce nonlinear transformation to enhance the representation ability of a model for complex features, and features of different time scales are weighted and fused to generate the comprehensive feature representation:

$${F}_{t} = {\sum }_{k = 1}^{K} {α}_{k} \cdot {\hat{H}}_{k} ,$$

wherein, K is the number of time scales. αₖ is a fusion weight at the time scale k, which is learned dynamically by the model through training.

Further, the short-term dynamic modeling includes: capturing local time-series features using dilated convolution. For a given input feature Zₜ, a calculation formula of the dilated convolution is:

$${h}_{t} = {\sum }_{k = 0}^{K - 1} {w}_{k} \cdot {x}_{t - k \cdot d} ,$$

wherein, hₜ is a convolution output at time t, K is a size of a convolution kernel, d is an expansion factor that controls a time jump step, and wₖ is a weight of the convolution kernel.

Further, the long-term trend modeling includes: modeling a nonlinear dependency relationship over a long time span by using Transformer based on a multi-head attention mechanism, wherein query, key and value matrices are first generated through linear transformation, weights between feature time steps are calculated based on the attention mechanism, and the results from different attention heads are spliced and linearly transformed through multi-head attention to generate a long-term feature representation; and finally a long-term branch maps the long-term feature representation Flong to a target prediction space through a linear layer.

Further, the performing noise fitting on the preliminary marine environment prediction data by using the generative adversarial network to generate the final marine environment prediction data includes: generating abnormal scenario data using a generator of the generative adversarial network, and learning the distribution of real data through adversarial training to generate abnormal data close to a real environment.

In a second aspect, a system for multimodal fusion prediction of a marine environment based on digital twinning includes:
a data acquisition module configured to acquire multimodal data of the marine environment, including satellite remote sensing, buoy sensor and weather station data;
a preprocessing module configured to perform data preprocessing on the acquired multimodal data;
a spatiotemporal correlation module configured to capture spatiotemporal correlation features of the multimodal data of the marine environment based on a dynamic multimodal graph neural network in a dynamic multimodal graph;
a feature representation module configured to perform multi-scale feature fusion on the spatiotemporal correlation features using a multi-scale gating unit to obtain a comprehensive feature representation;
a prediction module configured to predict the comprehensive feature representation using a hybrid time-series prediction framework to obtain preliminary marine environment prediction data, including short-term dynamic modeling and long-term trend modeling; and
a fitting module configured to perform noise fitting on the preliminary marine environment prediction data using a generative adversarial network to generate final marine environment prediction data.

In a third aspect, this disclosure provides a computer-readable storage medium, storing a plurality of instructions inside, the instructions being adapted to be loaded by a processor of a terminal device to implement the method for multimodal fusion prediction of the marine environment based on digital twinning.

In a fourth aspect, this disclosure provides a terminal device, including a processor and a computer-readable storage medium, wherein the processor is configured to implement each instruction; and the computer-readable storage medium is configured to store a plurality of instructions, the instructions being adapted to be loaded by the processor to implement the method for multimodal fusion prediction of the marine environment based on digital twinning.

In summary, this disclosure has the following beneficial technical effects.

According to this disclosure, the problems of insufficient data fusion, limited prediction accuracy and poor dynamic response capability existing in traditional marine environment monitoring and prediction technologies are effectively solved by means of an innovative combination of dynamic multimodal data fusion, hybrid time-series prediction framework (HTPF) and the multi-scale gated Tanh unit (M-GTU). A real-time acquisition and deep fusion technology of multi-source heterogeneous data based on the dynamic multimodal graph neural network (DM-GNN) comprehensively integrates multimodal data sources such as satellite remote sensing, buoy sensors, and meteorological stations, overcoming the difficulties of traditional methods in data isolation, heterogeneity, and complex correlation processing.

Combined with a multi-time-scale feature extraction mechanism of M-GTU, this system can accurately capture the short-term dynamic changes and long-term trends in the marine environment, and shows excellent sensitivity and robustness especially in the prediction of extreme events such as storms and tides. Through the synergy of the short-term dynamic modeling branch (based on a temporal convolution network) and the long-term trend modeling branch (based on a multi-head attention mechanism), this system exhibits excellent performances in both rapidly changing events and ecological evolution modeling over a long time span. The introduction of the generative adversarial network (GAN) enables this system to simulate the state of the marine environment under extreme scenarios, providing richer scenario analysis support for scientific decision-making. The prediction results achieve the optimal combination of short-term and long-term features through dynamic fusion, thereby significantly improving the accuracy and reliability of the prediction.

This system integrates an interactive 3D visualization platform to intuitively display a real-time status and future change trends of the marine environment. Users can use a flexible interactive interface to adjust area and time ranges or input scenario simulation parameters in real time, and dynamically view specific scenario simulations in complex environments. This intuitive and efficient visualization capability not only supports users in multi-dimensional analysis of marine environment changes, but also provides a scientific basis for optimizing resource management, ecological protection and emergency response strategies. Compared with traditional methods, this disclosure has achieved improvements in data processing efficiency, prediction accuracy, scenario simulation capabilities and visual interactive experience, providing key technical support for the construction of smart ocean and has broad application values in the fields of marine resource development, environmental protection, disaster prevention and control, etc.

The system for multimodal fusion prediction of the marine environment based on digital twinning proposed by this disclosure can be widely used in real-time monitoring and future status prediction of complex dynamic marine environments through deep integration and intelligent analysis of multi-source data. In marine resource management, the spatial distribution and time-series changes of temperature and salinity are predicted in this disclosure by fusing satellite remote sensing, buoy sensors and meteorological station data, thereby providing data support for fishery resource assessment and planning. In terms of marine disaster management, the impacts of extreme events such as typhoons and tsunamis on specific sea areas can be simulated in real time in this disclosure, so as to assist the government and relevant departments in formulating accurate evacuation and disaster emergency plans. In addition, this system supports real-time display and trend analysis of environmental monitoring data in combination with a three-dimensional dynamic visualization technology, and is of great value in public science popularization and scientific research applications. In particular, this disclosure demonstrates excellent performances and adaptability when dealing with complex changes across time scales and analyzing the interactions between marine ecosystems and climate.

### BRIEF DESCRIPTION OF DRAWINGS

FIG. 1 is a schematic diagram of a method for multimodal fusion prediction of a marine environment based on digital twinning according to Embodiment 1 of this disclosure; and

FIG. 2 is another schematic diagram of the method for multimodal fusion prediction of the marine environment based on digital twinning in Embodiment 1 of this disclosure.

### DETAILED DESCRIPTION OF THE EMBODIMENTS

This disclosure will be further described in detail below in conjunction with the accompanying drawings.

### Embodiment 1

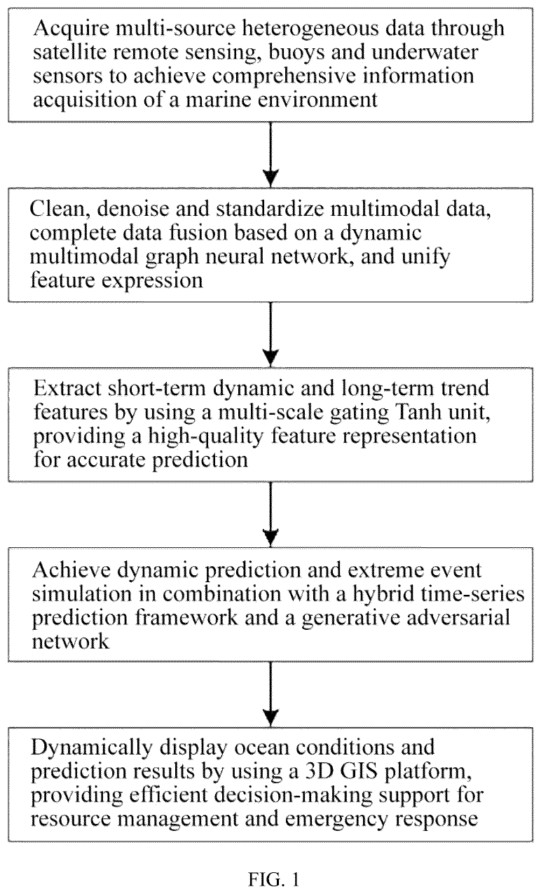

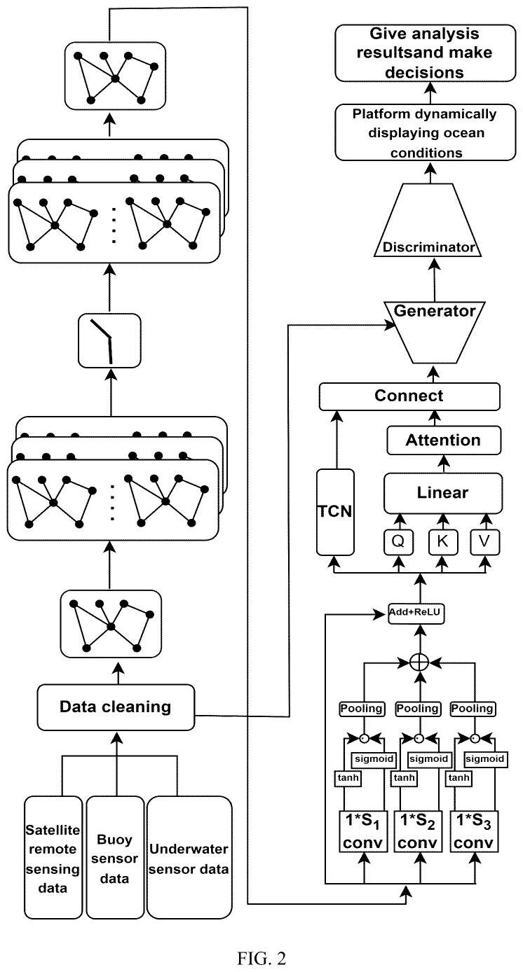

Referring to FIG. 1 and FIG. 2, a method for multimodal fusion prediction of a marine environment based on digital twinning in the present embodiment includes:
acquiring multimodal data of the marine environment, including satellite remote sensing, buoy sensors and weather station data;
performing data preprocessing on the acquired multimodal data;
capturing spatiotemporal correlation features of multimodal data of the marine environment based on a dynamic multimodal graph neural network;
performing multi-scale feature fusion on the spatiotemporal correlation features using a multi-scale gating unit to obtain a comprehensive feature representation;
predicting the comprehensive feature representation using a hybrid time-series prediction framework to obtain preliminary marine environment prediction data, including short-term dynamic modeling and long-term trend modeling; and
performing noise fitting on the preliminary marine environment prediction data using a generative adversarial network to generate the final marine environment prediction data.

Specifically, the method includes the following steps.

### S1. Acquiring Multimodal Data of a Marine Environment, Including Satellite Remote Sensing, Buoy Sensors and Weather Station Data.

The data acquisition of the marine environment relies on a multi-source sensor network, and real-time monitoring of physical parameters such as ocean temperature, salinity, flow velocity and waves, as well as chemical parameters such as dissolved oxygen, pH value and nutrient concentration, and meteorological parameters such as wind velocity, wind direction and atmospheric pressure are implemented by a distributed sensing device. After the data collected by the sensor is uploaded to a data center via wireless communication and uniformly calibrated through timestamps to ensure the time consistency.

### S2. Performing Data Preprocessing on the Acquired Multimodal Data.

In the data preprocessing, in order to make the acquired multimodal data adapt to input requirements of the dynamic multimodal graph neural network (DM-GNN), the preprocessing operation includes the following parts.
(1) Data cleaning: noise and outliers are removed, and abnormal data points that deviate greatly from a mean value are removed. A cleaning condition is set to be:

$${X}_{t}^{( i )} = \{ \begin{matrix}{X}_{t}^{( i )} , \vert {X}_{t}^{( i )} - {μ}_{i} \vert \leq 3 {σ}_{i} \\ NaN , \vert {X}_{t}^{( i )} - {μ}_{i} \vert > 3 {σ}_{i}\end{matrix} \} ,$$

wherein, μᵢ and σᵢ represent a mean value and a standard deviation calculated by an i^{th} data source in a historical time window.
(2) Missing value processing: a missing value is filled by a sliding average method. A filling method is set to be:

$${X}_{t}^{( i )} = \{ \begin{matrix}{X}_{t}^{i} , {X}_{t}^{i} \neq NaN \\ \frac{1}{k} {\sum }_{j = 1}^{k} {X}_{t - j}^{( i )} , {X}_{t}^{( i )} = NaN\end{matrix} \} ,$$

wherein, the missing value is a mean value of the past k moments as an estimated value of missing data at time t.
(3) Normalization processing: the ranges of feature values in different modes may vary greatly. In order to eliminate a dimension influence, a normalization method is used:

$${X}_{t}^{( i )} = \frac{{x}_{t - {μ}_{i}}^{( i )}}{{σ}_{i}} ,$$

wherein, μᵢ and σᵢ represent the mean value and the standard deviation calculated by the i^{th} data source in the historical time window.

### S3. Dynamic Multimodal Fusion.

Dynamic multimodal fusion is a key step to achieve efficient integration of multi-source heterogeneous data. With the support of dynamic multimodal fusion, this system can not only achieve deep modeling of spatiotemporal features among different modal data sources, but also provide precise support for a plurality of practical application scenarios. For example:
extreme event scenario prediction: this system generates realistic typhoon and tsunami scenario data through a generative adversarial network (GAN) module, and can accurately simulate ocean current changes and wave growing ranges under extreme weather conditions in combination with dynamic prediction results, providing a decision-making basis for disaster prevention and control.

Pollution diffusion simulation and emergency response: a diffusion path and an impact range of pollutants (such as oil spills or chemical wastes) are simulated by an intelligent analysis module, and high-risk areas can be quickly identified in combination with dynamically updated prediction data to assist in the efficient deployment of emergency resources.

Ecological evolution trend analysis: with the support of a long-term trend modeling module, this system can perform modeling analysis on the impacts of seasonal climate changes on ocean temperature and salinity, evaluate the long-term impact of environmental changes on the distribution of fish habitats, and optimize the development of fishery resources.

In view of the problems of differences in spatiotemporal resolution, physical properties and data formats among different data sources, this system adopts a dynamic heterogeneous graph modeling method to capture spatiotemporal correlation features between multimodal data by virtue of a dynamic multimodal graph neural network (DM-GNN). Specifically, the multimodal data of the marine environment (including satellite remote sensing, buoy sensors and meteorological station data) is modeled as a dynamic heterogeneous graph Gₜ=(V, Eₜ, Aₜ), where a node set V represents each modal data source, an edge set Eₜ represents a dynamic relationship between the data sources, and an adjacency matrix Aₜ defines an association weight between nodes.

The node set V includes feature vectors of multimodal data sources, and each node vi E V represents the i^{th} data source, which is characterized by

$${X}_{t}^{( i )} ,$$

i.e., an observed value at time t, in the specific form:

$${X}_{t} = [ {X}_{t}^{( 1 )} , {X}_{t}^{( 2 )} , … , {X}_{t}^{( N )} ] ,$$

wherein,

$${X}_{t}^{( i )} ∈ {ℝ}^{{F}_{i}} ,$$

is a feature dimension of a data source i. Through a node feature matrix Xₜ, this system uniformly represents multimodal data. The dynamic adjacency matrix Aₜ defines the similarity between nodes, which is calculated as follows:

$${A}_{t} [ i , j ] = \frac{∅ ( {X}_{t}^{( i )} ) \cdot {∅ ( {x}_{t}^{( i )} )}^{T}}{‖ ∅ ( {X}_{t}^{( i )} ) ‖ \cdot ‖ ∅ ( {x}_{t}^{( i )} ) ‖} ,$$

wherein, Ø(⋅) is an embedding function configured to map node features into a unified high-dimensional representation space and eliminate scale differences between different modalities. By calculating the adjacency matrix through cosine similarity, the correlation between nodes can be accurately captured in a high-dimensional space.

To enhance the stability of the graph structure and prevent gradient explosion or vanishing problems, the adjacency matrix Aₜ is further standardized as a normalized adjacency matrix Ãₜ:

$${Ã}_{t} = {D}_{t}^{- \frac{1}{2}} {A}_{t} {D}_{t}^{- \frac{1}{2}} ,$$

wherein, Dₜ[i, i]=ΣⱼAₜ[i, j] is a degree matrix.

After the dynamic heterogeneous graph is constructed, the node features are propagated and updated through a graph convolution network (GCN). An updating formula for each layer of graph convolution operation is:

$${H}_{t}^{( l + 1 )} = σ ( {Ã}_{t} {H}_{t}^{( l )} {W}^{( l )} + {b}^{( l )} ) ,$$

wherein,

$${H}_{t}^{( l )}$$

is a node feature matrix of a 1^{st} layer, W^{(l)} is a weight matrix for linear transformation, b^{(l)} is a bias vector, and σ(⋅) is a nonlinear activation function.

Multi-layer graph convolution operation is used to gradually capture high-order features of a global graph structure by superimposing local neighborhood information. Finally, after L layers of convolution, a global spatiotemporal feature matrix output by this system is:

$${Z}_{t} = {H}_{t}^{( L )} .$$

The feature matrix Zₜ includes complex spatiotemporal correlations between multimodal data sources, providing a unified input for subsequent dynamic modeling and prediction.

### S4. Multi-Scale Gated Tanh Unit (M-GTU).

The multi-scale gated Tanh unit (M-GTU) is an important module for multi-time-scale modeling of spatiotemporal features, aiming to extract short-term dynamic and long-term trend features from a feature Zₜ generated by dynamic fusion. M-GTU learns the priority of features from different time scales by combining the convolution operation, the gating mechanism, and the nonlinear activation function.

Given an input feature matrix Zₜ, multi-time-scale features are extracted using convolution kernels Kₖ of different sizes:

$${H}_{k} = C o n v ( {Z}_{t} , {W}_{k} ) ,$$

wherein, Wₖ∈R^{K}^{ₖ}^{×F} is a convolution kernel of a time scale k, and Kₖ represents a convolution kernel size. The convolution operation slides over a time dimension of the input features to capture local features within different time windows.

The gating mechanism generates feature selection weights through a Sigmoid function to select which time scales have more important features:

$${g}_{k} = Sigmoid ( {H}_{k} {W}_{g} + {b}_{g} ) ,$$

wherein, gₖ is a gating weight matrix of the time scale k. W_{g} and b_{g} represent a weight and bias of the gating mechanism, respectively.

The feature after gating is:

$${\hat{H}}_{k} = tanh ( {H}_{k} ) ⊙ {g}_{k} ,$$

wherein, tanh( ) is a Tanh activation function, and ⊙ represents element-wise multiplication. Tanh activation is used to introduce nonlinear transformations to enhance the ability of the model to represent complex features.

The features in different time scales are weighted and fused to generate the comprehensive feature representation:

$${F}_{t} = {\sum }_{k = 1}^{k} {α}_{k} \cdot {\hat{H}}_{k} ,$$

wherein, K is the number of time scales. αₖ is a fusion weight of a time scale k, which is learned dynamically by the model through training.

After dynamic multimodal fusion and feature extraction are completed, this system enters an intelligent prediction and abnormal simulation module. This module aims to achieve accurate prediction of future marine environment conditions based on the high-dimensional spatiotemporal feature Zₜ, and generate possible extreme event scenarios by a hybrid time-series prediction framework (HTPF) in combination with the generative adversarial networks (GAN). The intelligent prediction module adopts the hybrid time-series prediction framework (HTPF), which captures both rapidly changing local characteristics and global trends across time spans by combining short-term dynamic modeling and long-term trend modeling.

### S5. Hybrid Time-Series Prediction Framework (HTPF).

### (1) Short-Term Dynamic Modeling.

A short-term dynamic modeling branch is based on a temporal convolution network (TCN) and captures local time-series features by using dilated convolution. The dilated convolution can expand a receptive field over a temporal dimension, thereby modeling longer temporal dependencies while maintaining the computational efficiency. Given an input feature Zₜ, a calculation formula of the dilated convolution is:

$${h}_{t} = {\sum }_{k = 0}^{K - 1} {w}_{k} \cdot {x}_{t - k \cdot d} ,$$

wherein, hₜ is a convolution output at time t, K is a convolution kernel size, d is an expansion factor that controls a time jump step, and wₖ is a weight of the convolution kernel.

The last layer of temporal convolutional feature hₜ is mapped to a target prediction value space:

$${Y}_{short} = {h}_{t} {W}_{short} + {b}_{short} ,$$

wherein, Wₛₕₒᵣₜ is a mapping weight matrix that maps a feature dimension d to an output target dimension. bₛₕₒᵣₜ is a bias term, and Yₛₕₒᵣₜ is a short-term prediction result at time t, which represents the response to rapid dynamic changes (such as swells or ocean current changes within a short time).

By stacking dilated convolutions layer by layer, TCN is able to capture multi-level dependencies in time series while avoiding information loss. The goal of the short-term dynamic branch is to respond quickly to short-term dramatic changes in the marine environment, such as rapid changes in swell or typhoon intensity.

### (2) Long-Term Trend Modeling.

A long-term trend modeling branch can model a nonlinear dependency relationship over a long time span using Transformer based on a multi-head attention mechanism. Given an input feature Fₜ, query, key, and value matrices are first generated through linear transformation:

$$Q = {F}_{t} {W}_{Q} , K = {F}_{t} {W}_{K} , V = {F}_{t} {W}_{V} ,$$

wherein, Q, K, V are query, key and value matrices, respectively; and W_{Q}, W_{K}, and W_{V} are weight matrices for feature transformation.

The attention mechanism is used to calculate a weight between feature time steps:

$$Attention ( Q , K , V ) = softmax ( \frac{Q {K}^{T}}{\sqrt{{d}_{k}}} ) V ,$$

wherein, dₖ is a dimension of a key vector, which is used to scale a dot product result. Multi-head attention is used to splice the results of different attention heads and perform linear transformation to generate a long-term feature representation:

$${F}_{long} = Concat ( {head}_{1} , … , {head}_{h} ) {W}_{O} ,$$

wherein, W₀ is a weight matrix of an output layer.

Finally, a long-term branch maps the long-term feature representation F_{long} to the target prediction space through a linear layer:

$${Y}_{long} = {F}_{long} {W}_{long} + {b}_{long} ,$$

wherein, W_{long} is a mapping weight matrix, b_{long} is a bias term, and Y_{long} represents a modeling result of long-term dependence.

Through a multi-layer stacked transformer structure, the long-term branch can effectively capture trend information over a long time span, such as seasonal temperature changes or slow changes in ocean surface salinity.

The prediction results of the short-term and long-term branches are weighted and fused to generate a final prediction value:

$${Y}_{{t}^{=}} β {Y}_{short} + ( 1 - β ) {Y}_{long} ,$$

wherein, β is a dynamically adjusted fusion weight, which represents a ratio of contributions of the short-term and long-term branches to the final prediction.

### S6. Generative Adversarial Network (GAN).

The generative adversarial network is configured to simulate extreme event scenarios, such as marine environment conditions under extreme weather conditions such as typhoons and tsunamis. GAN consists of a generator G and a discriminator D. The generator G receives random noise z~p_{z} and a reference feature Zₜ, and generates abnormal scenario data x′ with Yₜ as input:

$${x}^{′} = G ( [ z , {Z}_{t} , {Y}_{t} ] ; {θ}_{G} ) ,$$

wherein, z~p_{z} is a random noise vector, simulating potential unobservable factors; Zₜ is a feature matrix of multimodal fusion; Yₜ is a fusion value of short-term and long-term prediction; and θ_{G} is a parameter of the generator.

The discriminator D receives real data x~p_{data} or generates data x′, and outputs its authenticity probability D(x).

$$D ( x ) = σ ( f ( x ; {θ}_{D} ) ) ,$$

wherein, σ is a Sigmoid activation function; f(x;θ_{D}) is feature mapping of the discriminator; And θ_{D} is a parameter of the discriminator.

The goal of GAN is to make the data generated by the generator indistinguishable from real data through adversarial training. The optimization goal is:

$${min}_{G} {max}_{D} {E}_{x ∼ {p}_{d a t a}} [ log D ( x ) ] + {E}_{z ∼ {p}_{z}} [ log ( 1 - D ( G ( z , {Z}_{t} , {Y}_{t} ) ) ) ] ,$$

wherein, z~p_{z} is a random noise vector for introducing the diversity in generated data; Zₜ is a multimodal feature matrix, providing basic environmental features; and Yₜ is the fusion value of short-term and long-term predictions, which is used to provide a reference for future trends.

The generator learns the distribution of real data through adversarial training, thereby generating abnormal data that is close to a real environment.

### S7. Interactive Visualization.

An interactive visualization module intuitively presents prediction results and simulation scenarios of the marine environment through a three-dimensional GIS technology. Users can adjust the time range, geographic area and simulation parameters through the interactive interface to observe the dynamic changes and future trends of environmental status.

Through the combination of the three-dimensional GIS technology and virtual reality (VR) technology, this system achieves immersive visual analysis of the dynamic marine environment. Users can not only intuitively view real-time monitoring data such as wave heights and ocean current directions, but also adjust observation parameters according to specific needs. For example, in extreme event scenarios, users can simulate the impacts of different typhoon paths on specific areas and observe in real time wave growing ranges caused by typhoons and the impacts on coastal areas. At the same time, this system supports visual analysis of pollution events. Users can input location and diffusion parameters of pollution sources and dynamically simulate the diffusion ranges of pollutants under different meteorological conditions.

### Three-Dimensional Dynamic Display:

Based on a three-dimensional geographic coordinate system, this system maps a predicted value Yₜ and a real-time observed value Fₜ to a three-dimensional space and visualizes them through color gradient, vector field and other methods. A visualized mapping function is defined as:

$${V}_{v i s u a l} ( x , y , t ) = f ( {F}_{t} ( x , y ) ) ,$$

wherein, x, y are geographic coordinates, and f is a mapping function that converts numerical features into visual features.

### Data Output and Report Generation.

This system supports exporting prediction results and simulation data into a standardized report, including dynamically changing three-dimensional display screenshots; key indicators in simulation results (such as wave height, current velocity, and temperature); and trend analysis and error assessment. The interactive visualization module provides users with a flexible analysis tool, allowing the dynamic changes of complex marine environments to be intuitively presented, thereby supporting scientific research and decision-making.

A computer-readable storage medium stores a plurality of instructions inside, the instructions being adapted to be loaded by a processor of a terminal device to implement the method for multimodal fusion prediction of the marine environment based on digital twinning.

A terminal device includes a processor and a computer-readable storage medium, wherein the processor is configured to implement various instructions; and the computer-readable storage medium is configured to store a plurality of instructions, the instructions being adapted to be loaded by the processor to implement the method for multimodal fusion prediction of the marine environment based on digital twinning.

The above is a preferred embodiment of this disclosure, and is not intended to limit the protection scope of this disclosure. Therefore, all equivalent changes made according to the structure, shape and principle of this disclosure should be included in the protection scope of this disclosure.

What is claimed is:

1. A method for multimodal fusion prediction of a marine environment based on digital twinning, comprising:
acquiring multimodal data of the marine environment, comprising satellite remote sensing, buoy sensors, and weather station data;
performing data preprocessing on the acquired multimodal data;
capturing spatiotemporal correlation features of multimodal data of the marine environment based on a dynamic multimodal graph neural network;
performing multi-scale feature fusion on the spatiotemporal correlation features by using a multi-scale gating unit to obtain a comprehensive feature representation;
predicating the comprehensive feature representation by using a hybrid time-series prediction framework to obtain preliminary marine environment prediction data, comprising short-term dynamic modeling and long-term trend modeling; and
performing noise fitting on the preliminary marine environment prediction data by using a generative adversarial network to generate the final marine environment prediction data, wherein the performing data preprocessing on the acquired multimodal data comprises:
performing data cleaning, missing value processing and normalization processing on the acquired multimodal data, and wherein an averaging method is used for the missing value processing to fill a missing value, and a filling method is set to be:
$${X}_{t}^{( i )} = \{ \begin{matrix}{X}_{t}^{( i )} , {X}_{t}^{( i )} \neq NaN \\ \frac{1}{k} = {\sum }_{j = 1}^{k} {X}_{t - j}^{( i )} , {X}_{t}^{( i )} = NaN\end{matrix} \} ,$$
wherein, the missing value is a mean value of the past k moments as an estimated value of the missing data at time t;
wherein the capturing spatiotemporal correlation features of multimodal data of the marine environment based on the dynamic multimodal graph neural network comprises: modeling the multimodal data of the marine environment as a dynamic heterogeneous graph Gₜ=(V, Eₜ, Aₜ), wherein a node set V represents each modal data source, an edge set Eₜ represents a dynamic relationship between the data sources, and an adjacency matrix Aₜ defines an association weight between nodes; after the dynamic heterogeneous graph is constructed, the node features are propagated and updated through a graph convolution network GCN, and an updating formula of each layer of graph convolution operation is:
$${H}_{t}^{( l + 1 )} = σ ( {Ã}_{t} {H}_{t}^{( l )} {W}^{( l )} + {b}^{( l )} ,$$
wherein,
$${H}_{t}^{( l )}$$
is a node feature matrix of a 1^{st} layer, W^{(l)} is a weight matrix for linear transformation, b^{(l)} is a bias vector, and σ(⋅) is a nonlinear activation function;
wherein the performing multi-scale feature fusion on the spatiotemporal correlation features by using the multi-scale gating unit comprises: extracting short-term dynamic and long-term trend features from the generated features using a multi-scale gating Tanh unit, wherein local features in different time windows are captured by a convolution operation, feature selection weights are generated by a gating mechanism through a Sigmoid function, Tanh activation is used to introduce nonlinear transformation to enhance the representation ability of a model for complex features, and features of different time scales are weighted and fused to generate the comprehensive feature representation:
$${F}_{t} = {\sum }_{{k}_{1} = 1}^{{K}_{1}} {α}_{{k}_{1}} \cdot {\hat{H}}_{{k}_{1}} ,$$
wherein, K₁ is the number of time scales, and αₖ₁ is a fusion weight at a time scale k₁, which is dynamically learned by the model through training;
wherein the short-term dynamic modeling comprises: capturing local time-series features using dilated convolution; for a given input feature Zₜ, a calculation formula of the dilated convolution is:
$${h}_{t} = {\sum }_{{k}_{2} = 1}^{{K}_{2} - 1} {w}_{{k}_{2}} \cdot {x}_{t - {k}_{2} \cdot d} ,$$
wherein, hₜ is a convolution output at time t, K₂ is a convolution kernel size, d is an expansion factor that controls a time jump step, and wₖ₂ is a weight of the convolution kernel;
wherein the long-term trend modeling comprises: modeling a nonlinear dependency relationship over a long time span by using Transformer based on a multi-head attention mechanism, wherein query, key and value matrices are first generated through linear transformation, weights between feature time steps are calculated based on the attention mechanism, and the results from different attention heads are spliced and linearly transformed through multi-head attention to generate a long-term feature representation; finally, a long-term branch maps the long-term feature representation Flong to a target prediction space through a linear layer; and
wherein the performing noise fitting on the preliminary marine environment prediction data by using the generative adversarial network to generate the final marine environment prediction data comprises: generating abnormal scenario data using a generator of the generative adversarial network, and learning the distribution of real data through adversarial training to generate abnormal data close to a real environment.

2. A system for multimodal fusion prediction of a marine environment based on digital twinning, which is configured to implement the method for multimodal fusion prediction of the marine environment based on digital twinning according to claim 1, the system comprising:
a data acquisition module configured to acquire multimodal data of the marine environment, comprising satellite remote sensing, buoy sensor and weather station data;
a preprocessing module configured to perform data preprocessing on the acquired multimodal data;
a spatiotemporal correlation module configured to capture spatiotemporal correlation features of multimodal data of the marine environment based on a dynamic multimodal graph neural network;
a feature representation module configured to perform multi-scale feature fusion on the spatiotemporal correlation features using a multi-scale gating unit to obtain a comprehensive feature representation;
a prediction module configured to predict the comprehensive feature representation using a hybrid time-series prediction framework to obtain preliminary marine environment prediction data, comprising short-term dynamic modeling and long-term trend modeling; and
a fitting module configured to perform noise fitting on the preliminary marine environment prediction data using a generative adversarial network to generate final marine environment prediction data.

3. A computer-readable storage medium, storing a plurality of instructions inside, wherein the instructions are adapted to be loaded by a processor of a terminal device to implement the method according to claim 1.

4. A terminal device, comprising a processor and a computer-readable storage medium, wherein the processor is configured to implement various instructions; and the computer-readable storage medium is configured to store a plurality of instructions, the instructions being adapted to be loaded by the processor to implement the method according to claim 1.
